(19) United States
(12) Patent Application Publication
(10) Pub. No.: US 2021/0027765 A1
(43) Pub. Date: Jan. 28, 2021

(54) ELECTRONIC DEVICE AND OPERATING METHOD THEREOF

(71) Applicant: Samsung Electronics Co., Ltd., Suwon-si, Gyeonggi-do (KR)

(72) Inventors: Miji PARK, Suwon-si (KR); Younghak OH, Suwon-si (KR)

(21) Appl. No.: 16/979,652

(22) PCT Filed: Mar. 14, 2019
(86) PCT No.: PCT/KR2019/002963

§ 371 Date: Sep. 10, 2020

(30) Foreign Application Priority Data
Mar. 14, 2018 (KR) 10-2018-0029792

(51) Int. Cl. G10L 15/02; G10L 13/033; G10L 13/08; G10L 15/22

(52) U.S. Cl. CPC G10L 15/02; G10L 15/22; G10L 13/08; G10L 13/033

(57) ABSTRACT

An electronic device and an operating method thereof, according to various embodiments, can: acquire first voice data; detect first feature information from the first voice data; generate second voice data by using the first feature information; and output the second voice data.

### TECHNICAL FIELD

Various embodiments relate to an electronic device and an operating method thereof.

### BACKGROUND ART

With the development of technology, electronic devices are additionally provided with various functions and perform complex functions. For example, an electronic device may perform a mobile communication function, a data communication function, a data output function, a data storage function, a video making function, a voice recording function, a voice secretary function, etc. Such an electronic device may operate based on a user's voice command. In addition, the electronic device may convert text data into an audio signal of a voice which is set by default, and may output the voice.

### DISCLOSURE OF INVENTION

### Technical Problem

However, the electronic device described above may have a problem of low availability of a user's voice. That is, the electronic device just operates based on a user's voice, but does not convert text data into a user's voice. In addition, even if a writer of text data can be identified, a user of the electronic device may have difficulty in identifying the writer of the text data only with an audio signal outputted from the electronic device.

### Solution to Problem

An electronic device according to various embodiments may include an input device, at least one processor operatively connected to the input device, and a memory operatively connected to the processor.

According to various embodiments, the memory may store instructions that, when executed, cause the processor to: acquire first voice data through the input device; detect first feature information from the first voice data; generate second voice data by using the first feature information; and output the second voice data.

According to various embodiments, an operating method of an electronic device may include: acquiring first voice data; detecting first feature information from the first voice data; generating second voice data by using the first feature information; and outputting the second voice data.

### Advantageous Effects of Invention

The electronic device according to various embodiments may have high availability in using a user's voice. That is, the electronic device may convert text data into voice data based on a user's voice, and may output the voice data. By doing so, the electronic device may transmit or reproduce voice data as a user voice signal when a user of the electronic device cannot directly communicate. In addition, a listener of voice data can identify the user of the electronic device from the voice data. Likewise, the user of the electronic device can identify a writer of text data from voice data outputted from the electronic device.

### BRIEF DESCRIPTION OF DRAWINGS

FIG. 1 is a block diagram of an electronic device in a network environment according to various embodiments;

FIG. 2 is a sequence diagram of an operating method of an electronic device according to various embodiments;

FIG. 3 is a sequence diagram of a first feature information storing operation according to an embodiment;

FIG. 4 is a view provided to explain the first feature information storing operation according to an embodiment;

FIG. 5 is a sequence diagram of a second voice data outputting operation according to a first embodiment;

FIGS. 6A and 6B are views provided to explain the second voice data outputting operation according to the first embodiment;

FIG. 7 is a sequence diagram of a second voice data outputting operation according to a second embodiment;

FIGS. 8, 9, 10, 11A and 11B are views provided to explain the second voice data outputting operation according to the first embodiment;

FIG. 12 is a sequence diagram of a second voice data outputting operation according to a third embodiment;

FIG. 13 is a view provided to explain the second voice data outputting operation according to the third embodiment;

FIG. 14 is a sequence diagram of an operating method of an external device according to the third embodiment;

FIG. 15 is a view illustrating an example of a signal flowchart between an electronic device and an external device according to the third embodiment; and

FIG. 16 is a view illustrating another example of a signal flowchart between the electronic device and the external device according to the third embodiment.

### BEST MODE FOR CARRYING OUT THE INVENTION

Hereinafter, various embodiments of the disclosure will be described with reference to the accompanying drawings.

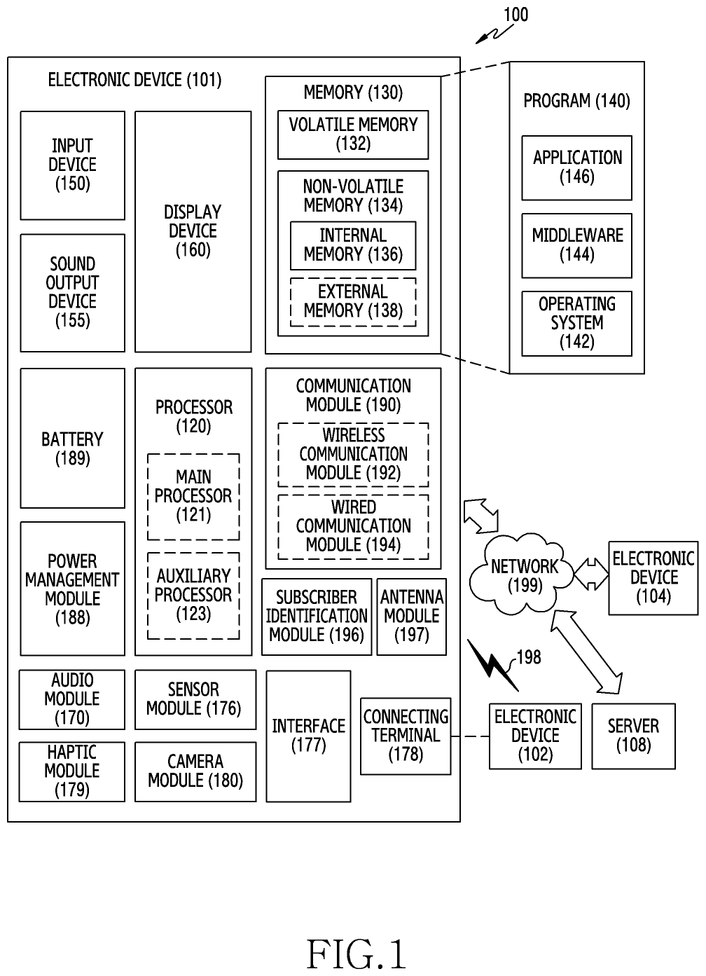

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by another component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming call. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include one or more antennas, and, therefrom, at least one antenna appropriate for a communication scheme used in the communication network, such as the first network 198 or the second network 199, may be selected, for example, by the communication module 190 (e.g., the wireless communication module 192). The signal or the power may then be transmitted or received between the communication module 190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

According to various embodiments, the electronic device 101 may acquire first voice data. The processor 120 may acquire first voice data from a user voice signal inputted through a microphone of the input device 150. The processor 120 may collect a user voice signal as first voice data while executing a pre-defined application. For example, the processor 120 may collect a user voice signal inputted through the microphone as first voice data while executing an application related to a call. In another example, the processor 120 may collect a user voice signal inputted through the microphone as first voice data while executing an application related to a voice secretary. In another example, the processor 120 may collect a user voice signal inputted through the microphone as first voice data while executing an application related to voice recording.

According to various embodiments, the electronic device 101 may detect first feature information from the first voice data. The processor 120 may detect the first feature information by parsing the first voice data. To achieve this, the processor 120 may acquire a frequency distribution of the first voice data. The processor 120 may detect the first feature information by parsing the frequency distribution of the first voice data. For example, the first feature information may include at least one of the number of vibrations, an amplitude, or a waveform of the first voice data.

According to various embodiments, the electronic device 101 may store the first feature information. The processor 120 may store the first feature information in the memory 130. The processor 120 may store the first feature information together with first identification information. The processor 120 may acquire first identification information, based on a user input received through the input device 150 or a touch circuitry. When the electronic device 101 is set to be used by a plurality of users, the processor 120 may store the first feature information in response to first identification information of each user.

According to various embodiments, the electronic device 101 may output second voice data. The processor 120 may output second voice data in association with an executed application. The processor 120 may guide whether second voice data can be outputted, while executing an application. The processor 120 may output the second voice data based on a user input. According to an embodiment, the processor 120 may output the second voice data based on the first feature information. According to another embodiment, the processor 120 may output the second voice data based on second feature information which is stored by default. According to another embodiment, the processor 120 may output the second voice data based on third feature information received from an external device (for example, the server 108). For example, the processor 120 may transmit the second voice data through the communication module 190. The processor 120 may transmit the second voice data as a user voice signal while executing an application related to a call. In another example, the processor 120 may reproduce the second vice data through the sound output device 155.

The electronic device 101 according to various embodiments may include the input device 150, the at least one processor 120 operatively connected to the input device 150, and the memory 130 operatively connected to the processor 120.

According to various embodiments, the memory 130 may store instructions that, when executed, cause the processor 120 to: acquire first voice data through the input device 150; detect first feature information from the first voice data; generate second voice data by using the first feature information; and output the second voice data.

According to various embodiments, the electronic device 101 may further include the communication module 190 operatively connected to the processor 120.

According to various embodiments, the instructions may cause the processor 120 to transmit the second voice data as a user voice signal through the communication module 190 while performing a call through the communication module 190.

According to various embodiments, the instructions may cause the processor 120 to collect the first voice data from a user voice signal through the input device 150 while performing a call through the communication module 190.

According to various embodiments, the instructions may cause the processor 120 to store the first feature information together with first identification information.

According to various embodiments, the electronic device 101 may further include the sound output device 155 operatively connected to the processor 120.

According to various embodiments, the instructions may cause the processor 120 to: generate the second voice data by using the first feature information, based on selection of the first identification information; and reproduce the second voice data through the sound output device 155.

According to various embodiments, the instructions may cause the processor 120 to convert text data into the second voice data.

According to various embodiments, the text data may be received from an external electronic device (for example, the electronic device 102, 104) or inputted through the input device 150.

According to various embodiments, the instructions may cause the processor 120 to generate second voice data by using third feature information received from an external device (for example, the server 108).

According to various embodiments, the external device (for example, the server 108) may store the third feature information together with second identification information.

According to various embodiments, the instructions may cause the processor 120 to: request the third feature information from the external device (for example, the server 108) through the communication module 190, based on selection of the second identification information; receive the third feature information from the external device (for example, the server 108) through the communication module 190; generate the second voice data by using the third feature information; and reproduce the second voice data through the sound output device 155.

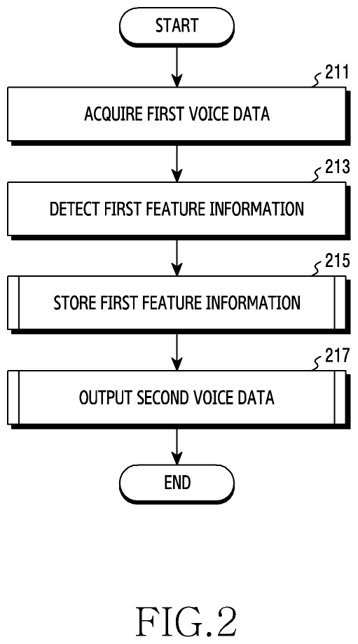

FIG. 2 is a sequence diagram of an operating method of the electronic device 101 according to various embodiments.

Referring to FIG. 2, the electronic device 101 may acquire first voice data in operation 211. The processor 120 may acquire the first voice data from a user voice signal which is inputted through the microphone of the input device 150. The processor 120 may collect a user voice signal as first voice data while executing a pre-defined application. For example, the processor 120 may collect a user voice signal inputted through the microphone as first voice data while executing an application related to a call. In another example, the processor 120 may collect a user voice signal inputted through the microphone as first voice data while executing an application related to a voice secretary. In another example, the processor 120 may collect a user voice signal inputted through the microphone as first voice data while executing an application related to voice recording. The processor 120 may store the first voice data in the memory 130. According to an embodiment, the processor 120 may transmit the first voice data to an external device (for example, the server 108) through the communication module 190.

In operation 213, the electronic device 101 may detect first feature information from the first voice data. The processor 120 may detect the first feature information by parsing the first voice data. To achieve this, the processor 120 may acquire a frequency distribution of the first voice data. The processor 120 may detect the first feature information by parsing the frequency distribution of the first voice data. For example, the first feature information may include at least one of the number of vibrations, an amplitude, or a waveform of the first voice data. After detecting the first feature information, the processor 120 may delete the first voice data from the memory 130.

In operation 215, the electronic device 101 may store the first feature information. The processor 120 may store the first feature information in the memory 130. The processor 120 may store the first feature information together with first identification information. The processor 120 may acquire the first identification information based on a user input which is received through the input device 150 or a touch circuitry. To achieve this, the processor 120 may display a screen for inputting the first identification information on a graphic user interface (GUI) through the display device 160. The processor 120 may perform user authentication through at least one of the input device 150, the touch circuitry, or the sensor module 176, and may store the first feature information in response to the first identification information of the user when user authentication succeeds. When the electronic device 101 is set to be used by a plurality of users, the processor 120 may store the first feature information in response to first identification information of each user. According to an embodiment, the processor 120 may transmit the first feature information to an external device (for example, the server 108) through the communication module 190.

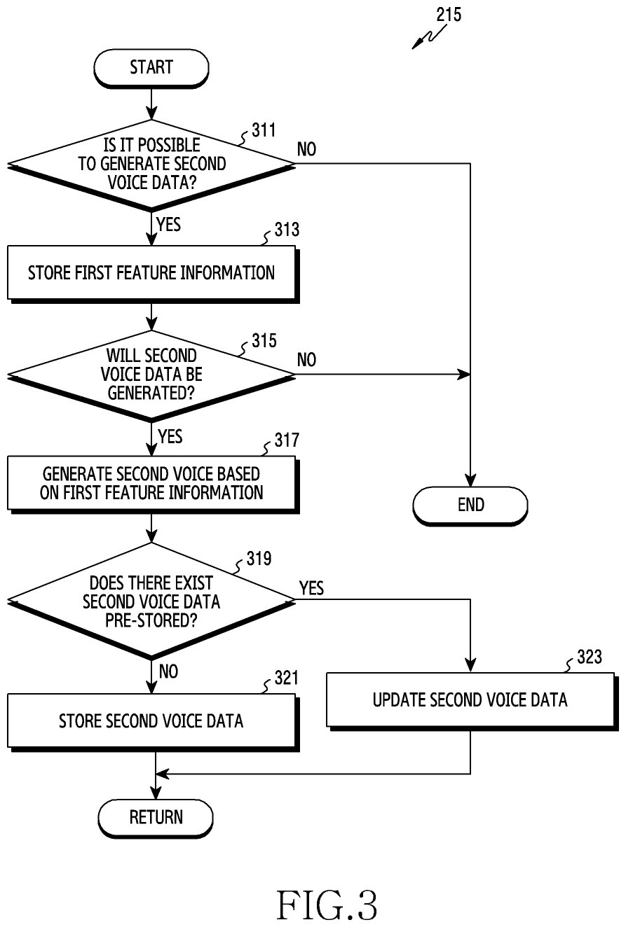

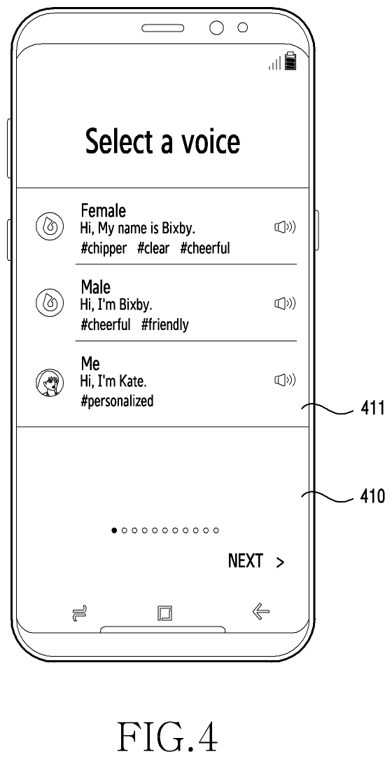

FIG. 3 is a sequence diagram of a first feature information storing operation according to an embodiment. FIG. 4 is a view provided to explain the first feature information storing operation according to an embodiment.

Referring to FIG. 3, in operation 311, the electronic device 101 may determine whether it is possible to generate second voice data. The processor 120 may determine whether it is possible to generate second voice data from the first feature information. For example, the processor 120 may determine whether the first feature information is sufficient to generate the second voice data.

When it is determined that it is possible to generate the second voice data in operation 311, the electronic device 101 may store the first feature information in operation 313. The processor 120 may store the first feature information in the memory 130. The processor 120 may match the first feature information with the first identification information and may store the first feature information. For example, the processor 120 may add an item 411 corresponding to first feature information, while displaying a graphic user interface (GUI) 410 indicating voices that can be outputted in the electronic device 101, as shown in FIG. 4. The processor 120 may set a default voice in response to the first feature information, based on a user input of selecting the item 411 corresponding to the first feature information. After storing the first feature information, the processor 120 may delete the first voice data from the memory 130.

In operation 315, the electronic device 101 may determine whether to generate the second voice data. The processor 120 may determine whether text data pre-defined to generate second voice data is stored.

When it is determined that the second voice data should be generated in operation 315, the electronic device 101 may generate the second voice data in operation 317. The processor 120 may generate the second voice data based on the first feature information. The processor 120 may convert text data into the second voice data by using the first feature information. In operation 319, the electronic device 101 may determine whether there exists second voice data that is pre-stored. The processor 120 may determine whether second voice data is stored in the memory 130, in response to at least one of the first identification information or the first feature information.

When it is determined that there does not exist the second voice data pre-stored in operation 319, the electronic device 101 may store the second voice data in operation 321. The processor 120 may store the second voice data in the memory 130. The processor 120 may store the second voice data in response to at least one of the first identification information or the first feature information. For example, the processor 120 may add the item 411 corresponding to the first feature information, while displaying the GUI 410 indicating the voices that can be outputted in the electronic device 101, as shown in FIG. 4. The processor 120 may set a default voice in response to the first feature information, based on a user input of selecting the item 411 corresponding to the first feature information. Thereafter, the electronic device 101 may return to FIG. 2.

When it is determined that there exists the second voice data pre-stored in operation 319, the electronic device 101 may update the second voice data in operation 323. The processor 120 may update the second voice data in the memory 130. The processor 120 may change the second voice data in response to at least one of the first identification information or the first feature information. For example, the processor 120 may delete the pre-stored second voice data, and may store the newly generated second voice data. Thereafter, the electronic device 101 may return to FIG. 2.

When it is determined that it is not possible to generate the second voice data in operation 311, the electronic device 101 may delete the first voice data. The processor 120 may delete the first voice data from the memory 130.

In operation 217, the electronic device 101 may output the second voice data. The processor 120 may output the second voice data in association with an executed application. The processor 120 may guide whether the second voice data can be outputted while executing the application. The processor 120 may output the second voice data based on a user input. According to an embodiment, the processor 120 may output the second voice data based on the first feature information. According to another embodiment, the processor 120 may output the second voice data based on second feature information which is stored by default. For example, when any one of the first feature information or the second feature information is set as a default voice, the processor 120 may output the second voice data in response to the default voice. According to another embodiment, the processor 120 may output the second voice data based on third feature information which is received from an external device (for example, the server 108). For example, the processor 120 may transmit the second voice data through the communication module 190. In another example, the processor 120 may reproduce the second voice data through the sound output device 155.

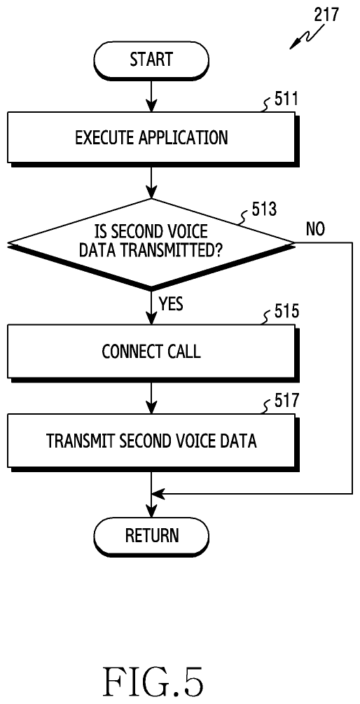

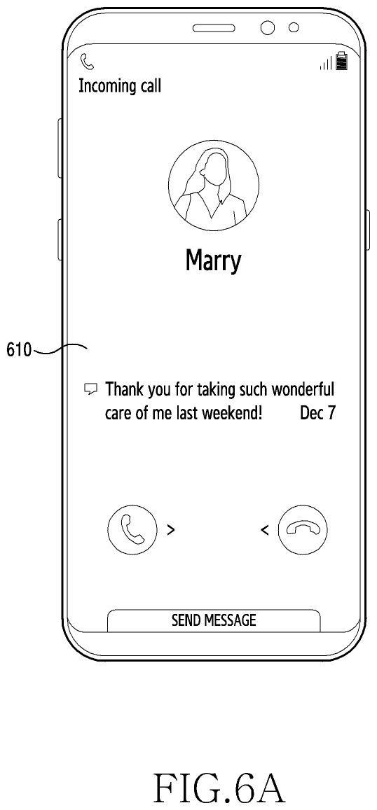

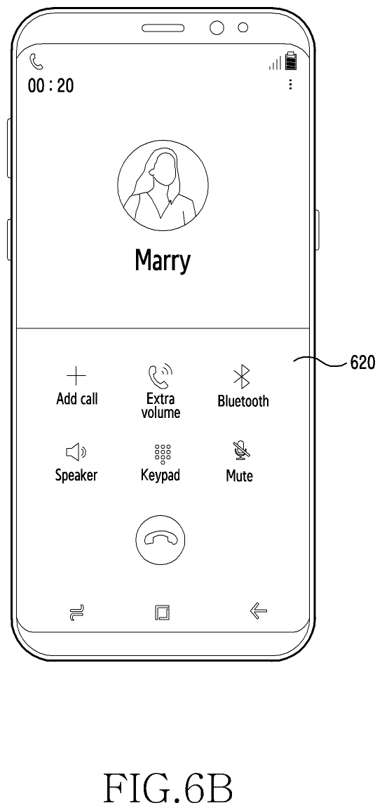

FIG. 5 is a sequence diagram of a second voice data outputting operation according to a first embodiment. FIGS. 6A and 6B are views provided to explain the second voice data outputting operation according to the first embodiment.

Referring to FIG. 5, in operation 511, the electronic device 101 may execute an application. The processor 120 may execute an application related to a call. While executing the application related to the call, the processor 120 may request a call from an external electronic device (for example, the electronic device 102, 104) through the communication module 190, based on a user input received through the input device 150 or the touch circuitry. Alternatively, when receiving a call from an external electronic device (for example, the electronic device 102, 104) through the communication module 190, the processor 120 may execute the application related to the call. For example, the processor 120 may display a graphic user interface 610 for receiving a call as shown in FIG. 6A.

In operation 513, the electronic device 101 may determine whether to transmit second voice data in association with the application being executed. The processor 120 may determine whether there is an input of a command to transmit the second voice data through the input device 150 or the touch circuitry. For example, the processor 120 may determine whether there is an input of a command to transmit the second voice data, as a user voice signal, through the microphone. In another example, the processor 120 may determine whether there is an input of a command to transmit the second voice data through a physical key, for example, a key for calling a voice secretary.

When it is determined that the second voice data should be transmitted in operation 513, the electronic device 101 may connect the call in operation 515. The processor 120 may connect the call with the external electronic device (for example, the electronic device 102, 104) through the communication module 190. For example, the processor 120 may display a graphic user interface 620 related to the call as shown in FIG. 6B.

In operation 517, the electronic device 101 may transmit the second voice data in association with the application being executed. The processor 120 may transmit the second voice data through the communication module 190. The processor 120 may transmit the second voice data as a user voice signal. The processor 120 may transmit the second voice data in response to a pre-set default voice. For example, when first feature information is set as a default voice, the processor 120 may transmit the second voice data corresponding to the first feature information. For example, the processor 120 may generate the second voice data based on pre-stored first feature information, and may transmit the second voice data. The processor 120 may convert pre-defined text data into the second voice data by using the first feature information. In another example, the processor 120 may transmit pre-stored second voice data. Through this, the external electronic device (for example, the electronic device 102, 104) may receive the second voice data as a call voice.

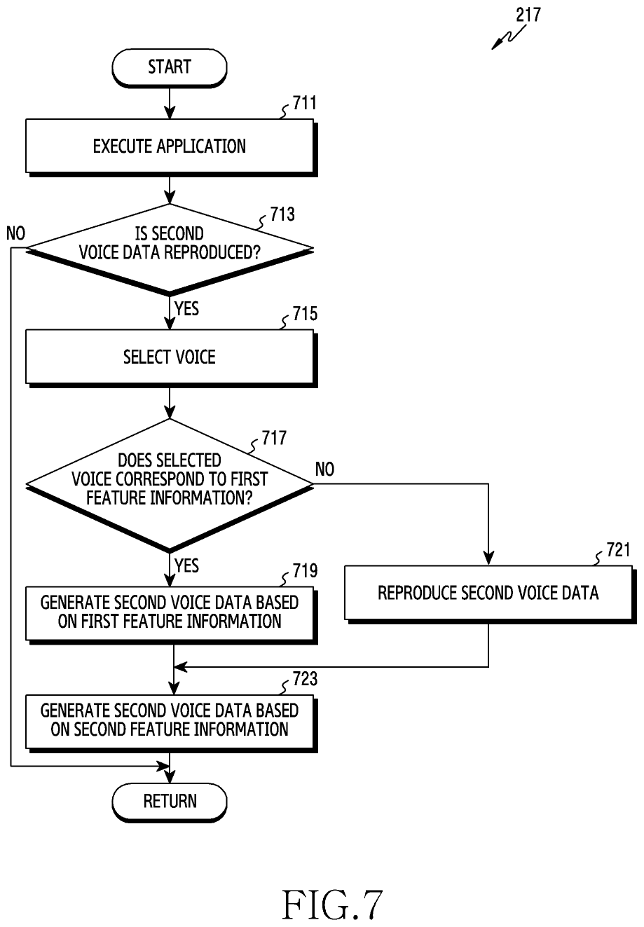

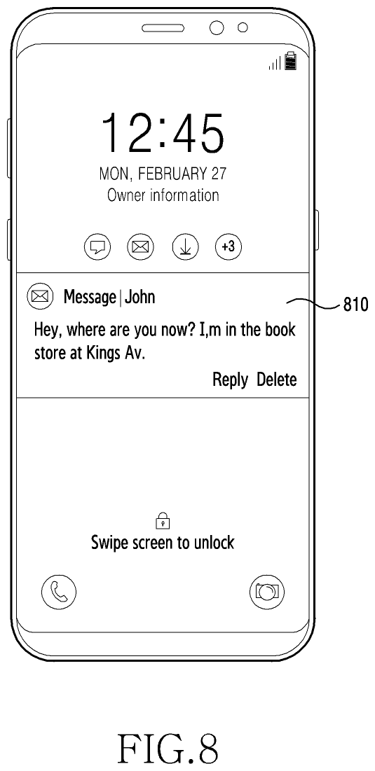

FIG. 7 is a sequence diagram of a second voice data outputting operation according to a second embodiment. FIGS. 8, 9, 10, 11A and 11B are views provided to explain the second voice data outputting operation according to the first embodiment.

Referring to FIG. 7, the electronic device 101 may execute an application in operation 711. The processor 120 may execute the application based on a user input which is received through the input device 150 or the touch circuitry. Alternatively, the processor 120 may execute the application, based on an external input received from an external electronic device (for example, the electronic device 102, 104) through the communication module 190.

In operation 713, the electronic device 101 may determine whether to reproduce second voice data in association with the application being executed. The processor 120 may determine whether to reproduce, as second voice data, text data selected in association with the application being executed. For example, the text data may be inputted through the input device 150 or the touch circuitry or may be received from the external electronic device (for example, the electronic device 102, 104). The processor 120 may determine whether there is an input of a command to reproduce the second voice data through the input device 150 or the touch circuitry.

For example, the user input or external input for executing the application and the command to reproduce the second voice data may be generated simultaneously. For example, the command to reproduce the second voice data may be inputted as a user voice signal through the microphone. In another example, the command to reproduce the second voice data may be inputted through a physical key, for example, a key for calling a voice secretary. In response to this, the processor 120 may execute the application and may determine that the second voice data should be reproduced.

When it is determined that the second voice data should be reproduced in operation 713, the electronic device 101 may select a voice in association with the application being executed in operation 715. The processor 120 may select the voice based on the text data. The processor 120 may select the voice in response to a writer of the text data. Alternatively, the processor 120 may select a pre-set default voice. Alternatively, the processor 120 may select the voice based on a user input. To achieve this, the processor 120 may display a graphic user interface for selecting a voice through the display device 160. For example, the processor 120 may display first identification information on the graphic user interface. The processor 120 may select the voice based on a user input which is received through the input device 150 or the touch circuitry.

In a first example, the processor 120 may execute an application related to a message. For example, the processor 120 may execute the application related to the message when receiving a message from an external electronic device (for example, the electronic device 102, 104) through the communication module 190. As shown in FIG. 8, the processor 120 may display a notification 810 related to a received message. When a command to check the message is inputted through the input device 150 or the touch circuitry in response to the notification 810, the processor 120 may execute the application related to the message. Thereafter, when a command to reproduce the second voice data is inputted through the input device 150 or the touch circuitry, the processor 120 may select a voice in response to the message. Alternatively, when a command to reproduce the message as the second voice data is inputted through the input device 150 or the touch circuitry in response to the notification 810, the processor 120 may execute the application related to the message and may select a voice in response to the message. When a writer of the message is identified, the processor 120 may select a voice in response to the writer of the message, but otherwise, the processor 120 may select a default voice.

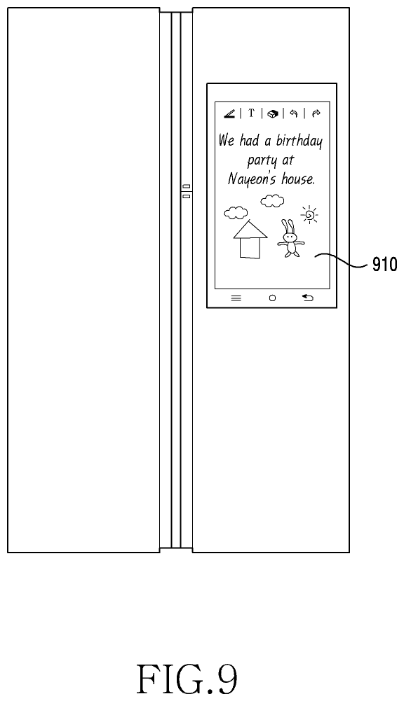

In a second example, the processor 120 may execute an application related to a memo. For example, the processor 120 may execute the application related to the memo, based on a user input received through the input device 150 or the touch circuitry. As shown in FIG. 9, the processor 120 may display a notification 910 related to a pre-stored memo. When a command to identify the memo is inputted through the input device 150 or the touch circuitry in response to the notification 910, the processor 120 may execute the application related to the memo. Thereafter, when a command to reproduce second voice data is inputted through the input device 150 or the touch circuitry, the processor 120 may select a voice in response to the memo. Alternatively, when a command to reproduce the memo as second voice data is inputted through the input device 150 or the touch circuitry in response to the notification 910, the processor 120 may execute the application related to the memo, and may select a voice in response to the memo. When a writer of the memo is identified, the processor 120 may select a voice in response to the writer of the memo, but otherwise, the processor 120 may select a default voice.

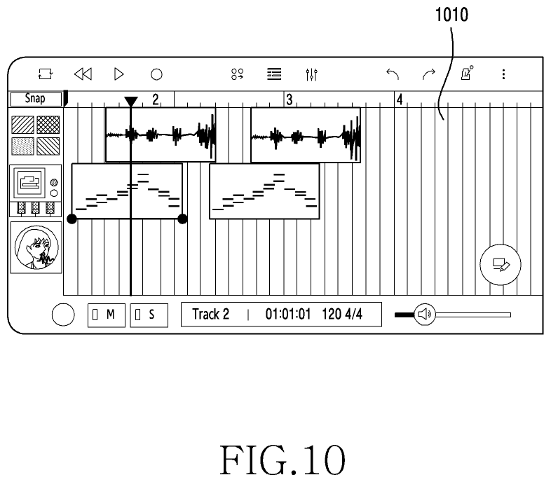

In a third example, the processor 120 may execute an application related to music. For example, the processor 120 may execute the application related to the music, based on a user input received through the input device 150 or the touch circuitry. As shown in FIG. 10, the processor 120 may display a graphic user interface 1010 related to music. When a command to reproduce lyrics as second voice data is inputted through the input device 150 or the touch circuitry, the processor 120 may select a default voice.

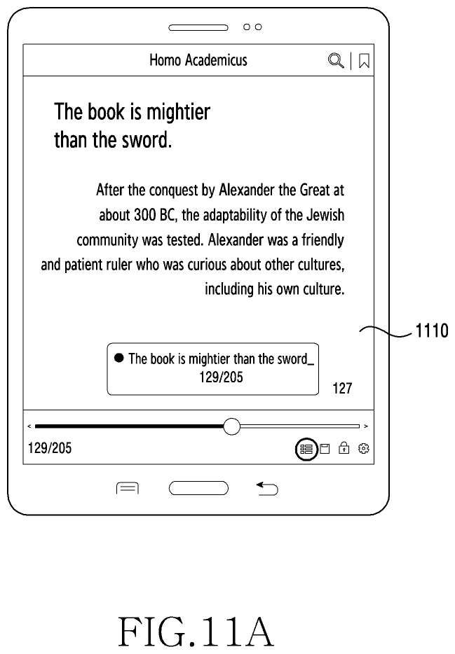

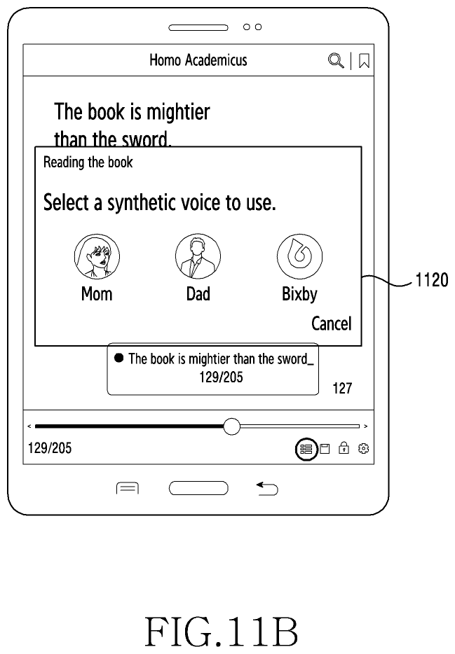

In a fourth example, the processor 120 may execute an application related to an electronic book. For example, the processor 120 may execute the application related to the electronic book, based on a user input received through the input device 150 or the touch circuitry. As shown in FIG. 11A, the processor 120 may display an application 1110 related to an electronic book. When a command to reproduce the electronic book as second voice data is inputted through the input device 150 or the touch circuitry, the processor 120 may display a graphic user interface 1120 to select a voice as shown in FIG. 11B. The processor 120 may select a voice based on a user input received through the input device 150 or the touch circuitry. Alternatively, when the command to reproduce the electronic book as the second voice data is inputted through the input device 150 or the touch circuitry, the processor 120 may select a default voice.

In operation 717, the electronic device 101 may determine whether the selected voice corresponds to first feature information. The processor 120 may determine whether first identification information corresponding to the first feature information is selected. When it is determined that the selected voice corresponds to the first feature information in operation 717, the electronic device 101 may generate the second voice data based on the first feature information in operation 719. The processor 120 may convert text data into the second voice data by using the first feature information. When it is determined that the selected voice does not correspond to the first feature information in operation 717, the electronic device 101 may generate the second voice data based on second feature information in operation 721. The processor 120 may convert the text data into the second voice data by using the second feature information. In operation 723, the electronic device 101 may reproduce the second voice data in association with the application being executed. The processor 120 may reproduce the second voice data through the sound output device 155. In the middle of reproducing the second voice data, the processor 120 may turn off the display device 160.

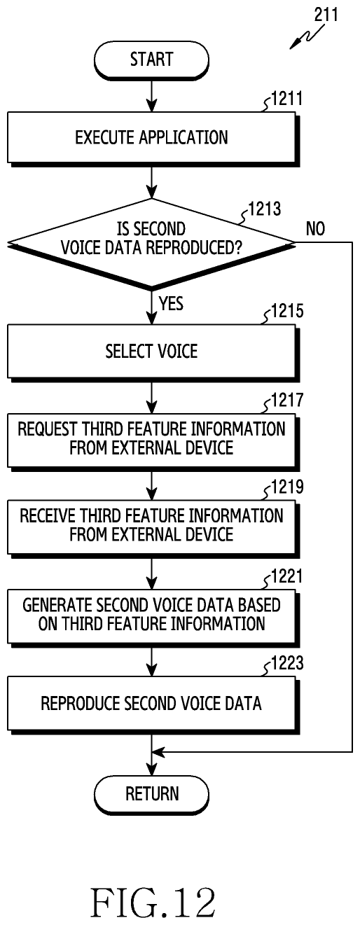

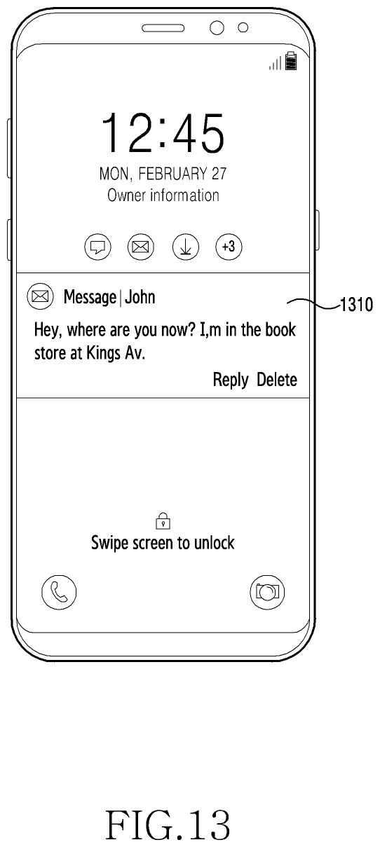

FIG. 12 is a sequence diagram of a second voice data outputting operation according to a third embodiment. FIG. 13 is a view provided to explain the second voice data outputting operation according to the third embodiment.

Referring to FIG. 12, in operation 1211, the electronic device 101 may execute an application. The processor 120 may execute the application based on a user input received through the input device 150 or the touch circuitry. Alternatively, the processor 120 may execute the application based on an external input which is received from an external electronic device (for example, the electronic device 102, 104) through the communication module 190.

In operation 1213, the electronic device 101 may determine whether to reproduce second voice data in association with the application being executed. The processor 120 may determine whether to reproduce, as second voice data, text data selected in association with the application being executed. For example, the text data may be inputted through the input device 150 or the touch circuitry, or may be received from an external electronic device (for example, the electronic device 102, 104). The processor 120 may determine whether there is an input of a command to reproduce the second voice data through the input device 150 or the touch circuitry.

For example, the user input or external input for executing the application and the command to reproduce the second voice data may be generated simultaneously. For example, the command to reproduce the second voice data may be inputted as a user voice signal through the microphone. In another example, the command to reproduce the second voice data may be inputted through a physical key, for example, a key for calling a voice secretary. In response to this, the processor 120 may execute the application and may determine that the second voice data should be reproduced.

When it is determined that the second voice data should be reproduced in operation 1213, the electronic device 101 may select a voice in association with the application being executed in operation 1215. The processor 120 may select a voice based on text data. For example, the processor 120 may select a voice in response to a writer of the text data. To achieve this, the processor 120 may identify second identification information of the external electronic device (for example, the electronic device 102, 104).

For example, the processor 120 may execute an application related to a message. For example, the processor 120 may execute the application related to the message when receiving a message from an external electronic device (for example, the electronic device 102, 104) through the communication module 190. As shown in FIG. 13, the processor 120 may display a notification 1310 related to a received message. When a command to check the message is inputted through the input device 150 or the touch circuitry in response to the notification 1310, the processor 120 may execute the application related to the message. Thereafter, when a command to reproduce the second voice data is inputted through the input device 150 or the touch circuitry, the processor 120 may select a voice in response to the message. Alternatively, when a command to reproduce the message as the second voice data is inputted through the input device 150 or the touch circuitry in response to the notification 1310, the processor 120 may execute the application related to the message and may select a voice in response to the message. The processor 120 may select a voice in response to a writer of the message. To achieve this, the processor 120 may identify second identification information of the external electronic device (for example, the electronic device 102, 104) in response to the message.

In operation 1217, the electronic device 101 may request third feature information from an external device (for example, the server 108). The processor 120 may request the third feature information from the external device (for example, the server 108) through the communication module 190. The processor 120 may transmit the second identification information to the external device (for example, the server 108), and may request the third feature information corresponding to the second identification information.

In operation 1219, the electronic device 101 may receive the third feature information from the external device (for example, the server 108). The processor 120 may receive the third feature information from the external device (for example, the server 108) through the communication module 190. The processor 120 may receive the third feature information corresponding to the second identification information from the external device (for example, the server 108).

In operation 1221, the electronic device 102 may generate second voice data based on the third feature information. The processor 120 may convert text data into the second voice data by using the third feature information. In operation 1223, the electronic device 101 may reproduce the second voice data in association with the application being executed. The processor 120 may reproduce the second voice data through the sound output device 155.

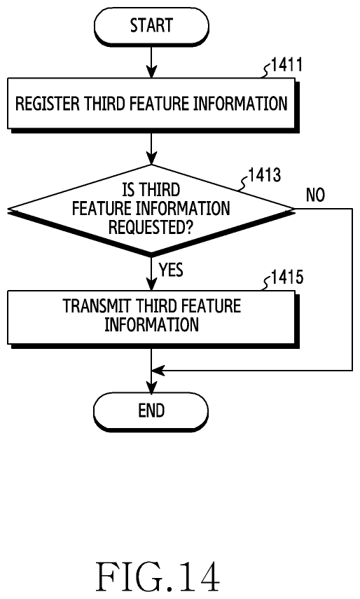

FIG. 14 is a sequence diagram of an operating method of an external device (for example, the server 108) for the third embodiment.

Referring to FIG. 14, third feature information may be registered at the external device (for example, the server 108) in operation 1411. The external device (for example, the server 108) may store the third feature information together with second identification information. The external device (for example, the server 108) may store the third feature information together with the second identification information, based on a request of an external electronic device (for example, the electronic device 108). In operation 1413, the external device (for example, the server 108) may receive a request for the third feature information. The external device (for example, the server 108) may receive the second identification information from the electronic device 101. In response to this, the external device (for example, the server 108) may transmit the third feature information in operation 1415. The external device (for example, the server 108) may detect the third feature information based on the second identification information. The external device (for example, the server 108) may transmit the third feature information to the electronic device 101.

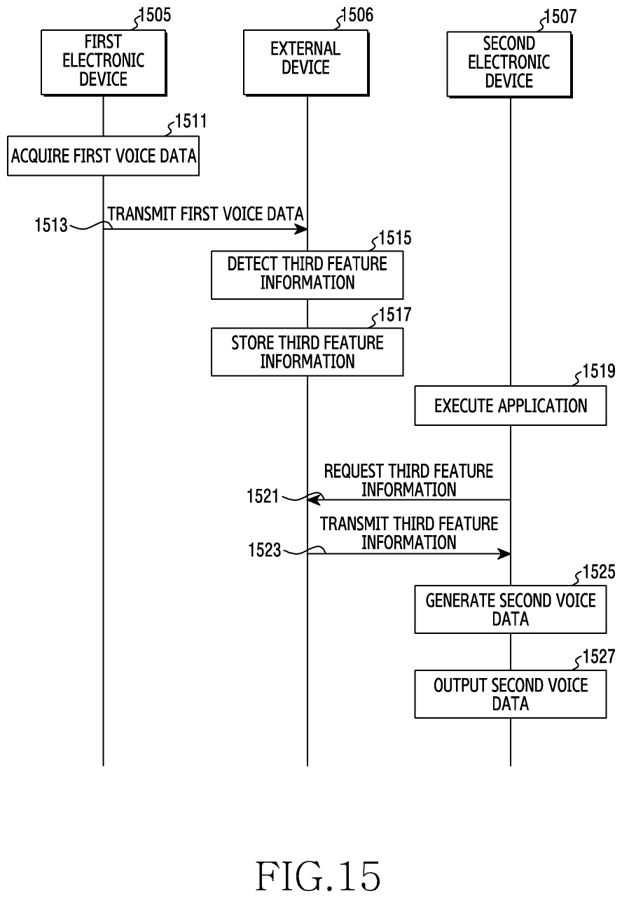

FIG. 15 is a view illustrating an example of a signal flowchart between electronic devices 1505, 1507 (for example, the electronic devices 101, 102, 104) and an external device 1506 (for example, the server 108) for the third embodiment.

Referring to FIG. 15, the first electronic device 1505 may acquire first voice data in operation 1511. The first electronic device 1505 may collect a user voice signal as first voice data while executing a pre-defined application. For example, the first electronic device 1505 may collect a user voice signal inputted through a microphone as first voice data. The first electronic device 1505 may transmit the first voice data to the external device 1506 in operation 1513. The first electronic device 1505 may transmit the first voice data together with second identification information.

The external device 1506 may detect third feature information from the first voice data in operation 1515. The external device 1506 may detect the third feature information by parsing the first voice data. To achieve this, the external device 1506 may acquire a frequency distribution of the first voice data. The external device 1506 may detect the third feature information by parsing the frequency distribution of the first voice data. For example, the third feature information may include at least one of the number of vibrations, an amplitude, or a waveform of the first voice data. The external device 1506 may store the third feature information in operation 1517. The external device 1506 may store the third feature information together with second identification information.

The second electronic device 1507 may execute an application in operation 1519. In operation 1521, the second electronic device 1507 may request the third feature information from the external device 1506 in association with the application being executed. The second electronic device 1507 may execute the application based on a user input for executing the application, and may request the third feature information from the external device 1506. Alternatively, the second electronic device 1507 may request the third feature information from the external device 1506, based on a user input for outputting second voice data, while executing the application. The second electronic device 1507 may transmit the second identification information to the external device 1506, and may request the third feature information corresponding to the second identification information.

In operation 1523, the external device 1506 may transmit the third feature information to the second electronic device 1507. In response to the request from the second electronic device 1507, the external device 1506 may detect the third feature information corresponding to the second identification information. The external device 1506 may transmit the third feature information corresponding to the second identification information to the second electronic device 1507.

The second electronic device 1507 may generate second voice data, based on the third feature information, in operation 1525. The second electronic device 1507 may convert text data related to the application being executed into the second voice data, by using the third feature information. The second electronic device 1507 may output the second voice data in association with the application being executed in operation 1527. For example, the second electronic device 1507 may transmit the second voice data or may reproduce the second voice data.

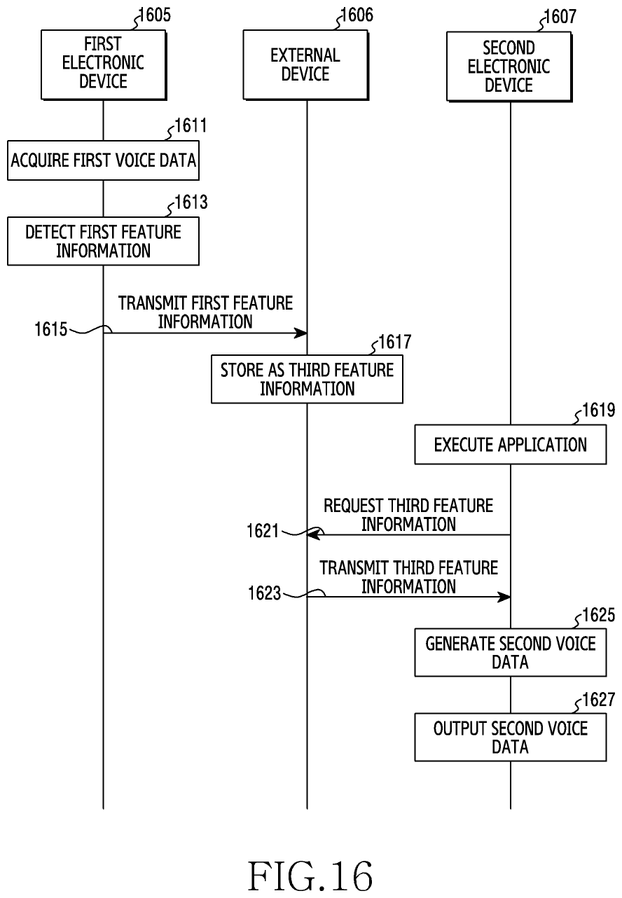

FIG. 16 is a view illustrating another example of a signal flowchart between electronic devices 1605, 1607 (for example, the electronic devices 101, 102, 104) and an external device 1606 (for example, the server 108) for the third embodiment.

Referring to FIG. 16, the first electronic device 1605 may acquire first voice data in operation 1611. The first electronic device 1605 may collect a user voice signal as first voice data while executing a pre-defined application. For example, the first electronic device 1605 may collect a user voice signal inputted through a microphone as first voice data.

The first electronic device 1605 may detect first feature information from the first voice data in operation 1613. The first electronic device 1605 may detect the first feature information by parsing the first voice data. To achieve this, the first electronic device 1605 may acquire a frequency distribution of the first voice data. The first electronic device 1605 may detect first feature information by parsing the frequency distribution of the first voice data. For example, the first feature information may include at least one of the number of vibrations, an amplitude, or a waveform of the first voice data. In operation 1615, the first electronic device 1605 may transmit the first feature information to the external device 1606. The first electronic device 1605 may transmit the first feature information together with second identification information.

In operation 1617, the external device 1606 may store the first feature information as third feature information. The external device 1606 may store the third feature information together with the second identification information.

The second electronic device 1607 may execute an application in operation 1619. In operation 1621, the second electronic device 1607 may request third feature information from the external device 1603 in association with the application being executed. The second electronic device 1607 may execute the application based on a user input for executing the application, and may request the third feature information from the external device 1606. Alternatively, the second electronic device 1607 may request the third feature information from the external device 1606, based on a user input for outputting second voice data, while executing the application. The second electronic device 1607 may transmit the second identification information to the external device 1606, and may request the third feature information corresponding to the second identification information.

In operation 1623, the external device 1606 may transmit the third feature information to the second electronic device 1607. The external device 1606 may detect the third feature information corresponding to the second identification information in response to the request from the second electronic device 1607. The external device 1606 may transmit the third feature information corresponding to the second identification information to the second electronic device 1607.

In operation 1625, the second electronic device 1607 may generate second voice data based on the third feature information. The second electronic device 1607 may convert text data related to the application being executed into the second voice data by using the third feature information. In operation 1627, the second electronic device 1607 may output the second voice data in association with the application being executed. For example, the second electronic device 1607 may transmit the second voice data or may reproduce the second voice data.

An operating method of the electronic device according to various embodiments may include: acquiring first voice data; detecting first feature information from the first voice data; generating second voice data by using the first feature information; and outputting the second voice data.

According to various embodiments, outputting the second voice data may include transmitting the second voice data as a user voice signal while performing a call with an external electronic device (for example, the electronic device 102, 104).

According to various embodiments, acquiring the first voice data may include acquiring the first voice data from a user voice signal while performing a call with an external electronic device (for example, the electronic device 102, 104).

According to various embodiments, outputting the second voice data may include reproducing the second voice data.

According to various embodiments, the operating method of the electronic device 101 may further include storing the first feature information together with first identification information.

According to various embodiments, generating the second voice data may include generating the second voice data by using the first feature information based on selection of the first identification information.

According to various embodiments, generating the second voice data may include converting text data into the second voice data.

According to various embodiments, the text data may be received from an external electronic device (for example, the electronic device 102, 104) or may be inputted from a user.

According to various embodiments, the external device (for example, the server 108) may store the third feature information together with second identification information.

According to various embodiments, the operating method of the electronic device 101 may further include: requesting the third feature information from the external device (for example, the server 108), based on selection of the second identification information; receiving the third feature information from the external device (for example, the server 108); and generating the second voice data by using the third feature information.

According to various embodiments, a non-transitory computer-readable storage medium may store one or more programs for executing: acquiring first voice data; detecting first feature information from the first voice data; generating second voice data by using the first feature information; and outputting the second voice data.

According to various embodiments, outputting the second voice data may include transmitting the second voice data as a user voice signal while performing a call with an external electronic device (for example, the electronic device 102, 104).

According to various embodiments, outputting the second voice data may include reproducing the second voice data.

The electronic device 101 according to various embodiments may have high availability in using a user's voice. That is, the electronic device 101 may convert text data into voice data based on a user's voice, and may output the voice data. By doing so, the electronic device 101 may transmit or reproduce voice data as a user voice signal when a user of the electronic device 101 cannot directly communicate. In addition, a listener of voice data can identify the user of the electronic device from the voice data. Likewise, the user of the electronic device 101 can identify a writer of text data from voice data outputted from the electronic device 101.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
an input device;
at least one processor operatively connected to the input device; and
a memory operatively connected to the processor,
wherein the memory stores instructions that, when executed, cause the processor to:
acquire first voice data through the input device;
detect first feature information from the first voice data;
generate second voice data by using the first feature information; and
output the second voice data.

2. The electronic device of claim 1, further comprising a communication module operatively connected to the processor,
wherein the instructions cause the processor to transmit the second voice data as a user voice signal through the communication module while performing a call through the communication module.

3. The electronic device of claim 1, further comprising a communication module operatively connected to the processor,
wherein the instructions cause the processor to acquire the first voice data from a user voice signal through the input device while performing a call through the communication module.

4. The electronic device of claim 1, wherein the instructions cause the processor to store the first feature information together with first identification information.

5. The electronic device of claim 4, further comprising a sound output device operatively connected to the processor,
wherein the instructions cause the processor to:
generate the second voice data by using the first feature information, based on selection of the first identification information; and
reproduce the second voice data through the sound output device.

6. The electronic device of claim 1, wherein the instructions cause the processor to convert text data into the second voice data.

7. The electronic device of claim 6, wherein the text data is received from an external electronic device or inputted through the input device.

8. The electronic device of claim 1, wherein the instructions cause the processor to generate second voice data by using third feature information received from an external device.

9. The electronic device of claim 8, wherein the external device is configured to store the third feature information together with second identification information.

10. The electronic device of claim 9, further comprising:
a communication module operatively connected to the processor; and
a sound output device operatively connected to the processor,
wherein the instructions cause the processor to:
request the third feature information from the external device through the communication module, based on selection of the second identification information;
receive the third feature information from the external device through the communication module;
generate the second voice data by using the third feature information; and
reproduce the second voice data through the sound output device.

11. An operating method of an electronic device, the method comprising:
acquiring first voice data;
detecting first feature information from the first voice data;
generating second voice data by using the first feature information; and
outputting the second voice data.

12. The method of claim 11, wherein outputting the second voice data comprises transmitting the second voice data as a user voice signal while performing a call with an external electronic device.

13. The method of claim 11, wherein acquiring the first voice data comprises acquiring the first voice data from a user voice signal while performing a call with an external electronic device.

14. The method of claim 11, wherein outputting the second voice data comprises reproducing the second voice data.

15. The method of claim 14, further comprising storing the first feature information together with first identification information.

16. The method of claim 15, wherein generating the second voice data comprises generating the second voice data by using the first feature information based on selection of the first identification information.

17. The method of claim 11, wherein generating the second voice data comprises converting text data into the second voice data.

18. The method of claim 17, wherein the text data is received from an external electronic device or inputted from a user.

19. The method of claim 14, wherein an external device stores third feature information together with second identification information.

20. The method of claim 19, further comprising requesting the third feature information from the external device, based on selection of the second identification information; receiving the third feature information from the external device; and generating the second voice data by using the third feature information.
